(19) United States
(12) Patent Application Publication
(10) Pub. No.: US 2013/0306731 A1
(43) Pub. Date: Nov. 21, 2013

(54) INDICIA READING TERMINAL OPERABLE FOR DATA INPUT ON TWO SIDES

(71) Applicant: Cassio Monaco Pedrao, Sao Paulo (BR)

(72) Inventor: Cassio Monaco Pedrao, Sao Paulo (BR)

(73) Assignee: HAND HELD PRODUCTS ,INC., Skaneateles Falls, NY (US)

(21) Appl. No.: 13/982,517

(22) PCT Filed: Jan. 31, 2011
(86) PCT No.: PCT/BR2011/000029

§ 371 Date: Jul. 30, 2013

(51) Int. Cl. G06K 7/10

(52) U.S. Cl. CPC G06K 7/1098
USPC 235/462.3

(57) ABSTRACT

Embodiments of an indicia reading terminal have a housing on which is disposed input/output devices on opposing sides of the housing The terminals are configured in one example to distinguish between the input/output devices, to activate one of the input/output devices for use by an end user, and to deactivate another of the input/output devices.

### BACKGROUND

1. Technical Field of the Disclosure

The subject matter of the present disclosure relates to indicia reading terminals and scanners, and more particularly, to embodiments of indicia reading terminals and scanners with multiple input/output devices on opposing sides of the terminal housing.

2. Discussion of Related Art

Indicia reading terminals and scanners (collectively, “terminals”) are available in multiple varieties. These terminals are useful to read and decode the information encoded in decodable indicia. Such decodable indicia are utilized generously, from encoding shipping and tracking information for packages, patient identification in hospitals, retail applications, to use on any number of forms and documents including, but not limited to, tax forms, order forms, transaction forms, survey forms, delivery forms, prescriptions, receipts, newspapers, product documents, reports, and the like.

Well-known among the varieties is the gun-style terminal as commonly seen at retail store checkout counters. Other styles of terminals are also available that provide enhanced functions, have input/output devices such as keyboards and displays, and include advanced networking communication capabilities. These other styles are often handheld devices that have a form factor similar to conventional personal digital assistants (PDAs) in which the input/output devices are positioned on one face of the terminal housing. But while this form factor simplifies the operation of the terminal by providing a single, interactive surface on the terminal housing, the resulting terminal may have physical characteristics (e.g., size, shape, and weight) that are less than optimal for certain applications and environments.

There is therefore a need for a terminal with a smaller, more compact form factor such as a terminal in which the input/output devices are on more than one side of the housing.

### SUMMARY

Embodiments of an indicia reading terminal have a housing on which is disposed input/output devices on opposing sides of the housing The terminals are configured in one example to distinguish between the input/output devices, to activate one of the input/output devices for use by an end user, and to deactivate another of the input/output devices.

### BRIEF DESCRIPTION OF THE DRAWINGS

So that the manner in which the above recited features of the present invention can be understood in detail, a more particular description of the invention briefly summarized above, may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Moreover, the drawings are not necessarily to scale, emphasis generally being placed upon illustrating the principles of certain embodiments of invention.

Thus, for further understanding of the concepts of the invention, reference can be made to the following detailed description, read in connection with the drawings in which:

FIG. 1 is a schematic diagram of an exemplary embodiment of an indicia reading terminal;

FIG. 2 is a perspective view of another exemplary embodiment of an indicia reading terminal;

FIG. 3 is a perspective view of the indicia reading terminal of FIG. 3 rotated 180°;

FIG. 4 is a perspective, exploded, assembly view of an example of an data capture device for use in the indicia reading terminals of FIGS. 1-3;

FIG. 5 is a perspective, assembled view of another example of a data capture device for use in the indicia reading terminals of FIGS. 1-3

FIG. 6 is a block diagram of an exemplary hardware platform for use in an indicia reading terminal such as the indicia reading terminals of FIGS. 1-3;

FIG. 7 is a block diagram of another exemplary hardware platform for use in an indicia reading terminal such as the indicia reading terminals of FIGS. 1-3; and

FIG. 8 is a block diagram of yet another exemplary hardware platform for use in an indicia reading terminal such as the indicia reading terminals of FIGS. 1-3.

### DETAILED DESCRIPTION

Broadly stated, embodiments of an indicia reading terminal (also, “terminal” or “handheld device”) read and decode decodable indicia (e.g., bar codes). These embodiments comprise a terminal housing and one or more input/output devices (e.g., a keyboard, keypad, and/or touch display). For convenience and to reduce the size of the terminal, the input/output devices are located on different sides, surfaces, and/or portions of the terminal housing. This configuration permits an end user to perform various operations such as data entry, image viewing, Web surfing, records management, etc., on different sides of the terminal. However, because these functions are not confined to a single side, the terminal has a form factor (or size and shape) that is much smaller, more compact, and in many cases lighter than conventional devices that offer the same and/or similar functions.

The terminals are also configured to activate and/or to deactivate each of the input/output devices based on the orientation of the terminal. This feature saves battery power as well as reduces unnecessary errors that may result from inadvertent use of one or more of the input/output devices. As discussed more below, exemplary terminals comprise an inertial device (e.g., an accelerometer and/or a gyroscope) to ascertain the orientation of the terminal such as to identify the location and/or position of surfaces and sides of the housing relative to an end user. Based on the orientation, the terminal is configured for operation of one or more of the input/output devices. For example, when the input/output devices are on opposing sides (e.g., the top and bottom) of the housing, the input/output device on the surface of the housing facing the end user is activated and the input/output device on the opposite or non-facing surface is deactivated.

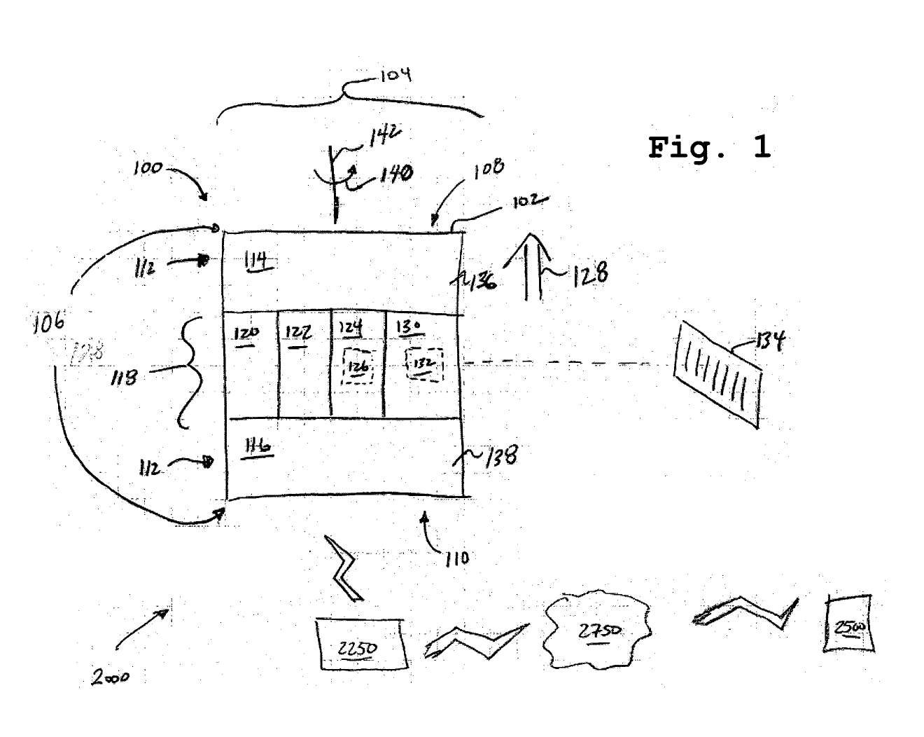

Turning now to the figures, FIG. 1 depicts in schematic form an exemplary embodiment of a terminal 100, which has a housing 102 with a form factor 104 and various interactive surfaces 106. The interactive surfaces 106 comprise a first interactive surface 108 and a second interactive surface 110 on which is disposed, respectively, one or more input/output devices 112 (e.g., a first input/output device 114 and a second input/output device 116). The terminal 100 also comprises hardware 118 such as processing hardware 120 and storage hardware 122, on which can be stored instructions (e.g., software and firmware) executed by the processing hardware 120. The hardware 118 also comprises orientation hardware 124 that includes an inertial device 126, which is used to determine a terminal orientation 128. The hardware 118 further comprises data capture hardware 130 with a data capture device 132 that is configured to acquire information from a decodable indicia 134 (e.g., bar codes).

The terminal orientation 128 reflects the position of the interactive surfaces 106 with respect to an end user (not shown). In the present example, the terminal orientation 128 describes the position of the first interactive surface 108 as being closer to the end user than the second interactive surface 110. This position is used to distinguish and/or to select between an active device 136 and a deactivated device 138. To change the selection of the active device 136 and the deactivated device 138, the hardware 118 is further configured to recognize re-orientation of the terminal 100, which occurs in one example by rotation 140 about an axis 142 so that the second interactive surface 110 is closer to the end user than the first interactive surface 108.

The terminal 100 is part of a system 2000 having at least one server such as a local server 2250, a remote server 2500, and a network 2750 through which the local server 2250 and the remote server 2500 can communicate. The configuration of the system 2000 is utilized for processing data such as captured data acquired with, e.g., the data capture hardware 130. For example, one or more of the local server 2250 and the remote server 2500 is utilized to entirely process the captured image data and operate the terminal 100 in a manner consistent with the disclosure below. In one embodiment, one or more of the processing hardware 120 and the storage hardware 122, or complementary ones thereof, are located outside of the terminal 100. Captured data is transferred between the terminal 100 to, e.g., the corresponding storage hardware 122 for immediate and/or further processing of the captured data. In another embodiment, processing steps disclosed, described, and contemplated herein can be distributed as between the terminal 100, the local server 2250, and the remote server 2500, with still other embodiments being configured for the image processing steps to be executed entirely by the terminal 100.

Various devices are contemplated for use as the inertial device 126. These devices include accelerometers and gyroscopes. However, while applicable in context of the present disclosure, this is not the only available technology. Rather other devices that track, detect, and recognize the orientation of the interactive surfaces 106 are likewise contemplated for use in embodiments of the terminal 100.

At a relatively high level, suitable devices are able to detect changes in the terminal orientation 128 such as changes that result from rotation 140 of the terminal 100. Rotation 140 changes the position of the first interactive surface 108 and the second interactive surface 110. In the present example, the inertial device 126 (and accompanying portions of the hardware 118) is configured to recognize when the position of each of the first interactive surface 108 and the second interactive surface 110 is inverted so that the second interactive surface 110 is closer to the end user, and vice versa.

The inertial device 126 can comprise integrated circuitry and/or discrete elements that are coupled with, e.g., the processing hardware 120. The devices can be silicon-based, such as are developed and manufactured using processes and techniques for semiconductor devices and microelectromechanical systems (MEMS). The resulting devices are integrated with the hardware 118 such as on a chip or chipset or as disposed on a substrate (e.g., a printed circuit board), which is enclosed or otherwise encapsulated in the housing 102. In one example, the inertial device 126 comprises a MEMSIC dual axis accelerometer or similar device, which is sized to fit according to the form factor 104.

The input/output devices 112 are configured in one aspect for data entry and data display. Other features are also contemplated such as for voice and image capture and transmission. Indeed complimentary devices for use as the input/output devices 112 are also be found on a personal digital assistant (PDA), cellular telephones, and mobile computers (e.g., laptops). In one example, the devices are selected based on settings in which the terminal 100 is used, such as hospitals and healthcare facilities where the end user may engage in certain tasks that require entry of information (e.g., patient records) and viewing of images (e.g., x-ray images). Examples of devices that can facilitate these tasks include, but are not limited to, key-based devices such as keyboards and keypads, displays such as touch-sensitive displays, as well as other devices with features suitable for this purpose. Combinations of these devices can also be used such as when a keyboard and a display device are positioned together such as on one of the interactive surfaces 106.

The data capture hardware 130 is configured with elements that decode data that is encoded in the decodable indicia 134, and in one construction the elements are responsive to a trigger signal initiated by an operator. The data capture hardware 130 can comprise optical readers and laser scanners as desired. The optical readers deploy an imaging module (not shown) that captures an image of the decodable indicia 134. The laser scanners are configured to generate a laser, which is used to capture data capture when the laser is directed onto the decodable indicia 134. In one embodiment, the data capture hardware 130 comprises the optical reader and the laser scanner.

The configuration of the data capture hardware 130 can define the configuration of the hardware 118, including the processing hardware 120 and the storage hardware 122. The capabilities of the processing hardware 120, as defined in one aspect by executable instructions, can also be determined by the symbology, coding, and other aspects of the decodable indicia (e.g., the decodable indicia 134). In one embodiment, the processing hardware 120 can be any type of CPU or microprocessor with exemplary functions designed to decode machine readable types of symbology, and particularly in connection with symbology found in data captured by way of the optical reader, the laser scanner, or both. Decoding is a term used to describe the successful interpretation of machine readable indicia (e.g., the decodable indicia 134) contained in an image captured by the data capture hardware 130 and/or on which impinges the laser.

Generally the decodable indicia 134 have data or information encoded therein. Information respecting various reference decode algorithms are available from various published standards, such as by the International Standards Organization (“ISO”). Examples may comprise one dimensional (or linear) symbologies, stacked symbologies, matrix symbologies, Composite symbologies, or other machine readable indicia. One dimensional (or linear) symbologies which may include very large to ultra-small, Code 128, Interleaved 2 of 5, Codabar, Code 93, Code 11, Code 39, UPC, EAN, MSI, or other linear symbologies. Stacked symbologies may include PDF, Code 16K, Code 49 or other stacked symbologies. Matrix symbologies may include Aztec, Datamatrix, Maxicode, QR Code or other 2D symbologies. Composite symbologies may include linear symbologies combined with stacked symbologies. Other symbology examples may comprise OCR-A, OCR-B, MICR types of symbologies. UPC/EAN symbology or barcodes are standardly used to mark retail products throughout North America, Europe and several other countries throughout the world.

In addition to the features and functions disclosed herein, embodiments of terminal 100 are amenable to various other features such as global positioning (GPS), use with radio frequency identification (RFID), and the like. Other compatible technologies such as card readers, printers, voice and data processing features, and myriad other technologies can be incorporated as part of the terminal 100 and related embodiments. While these features may not be explicitly described, such features may be implemented in hardware 118, separate from one or more of the identified components of hardware 118, or incorporated therein. The inventor recognizes that those artisans familiar with the relevant technology and terminal and scanner arts will understand the scope of these features, so additional details are not necessary nor provided herein.

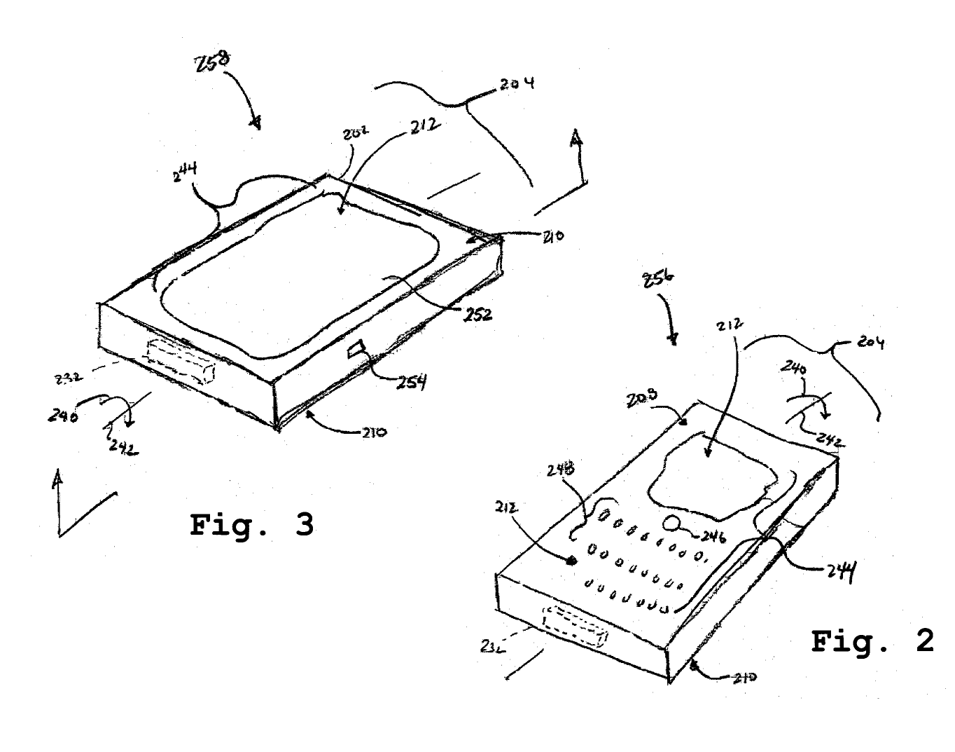

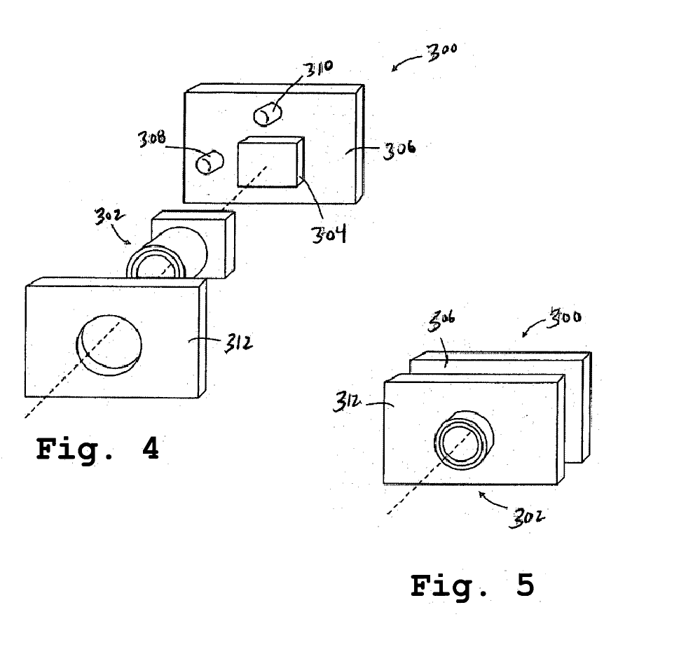

FIGS. 2 and 3 provide additional details of indicia reading terminals of the present disclosure. Like numerals are used to identify like components as between FIGS. 1-3, except the numerals are increased by 100. The terminal 200 comprises, for example, a housing 202 with a form factor 204, a first interactive side 204 and a second interactive side 210, and input/output devices 212. The terminal 200 is shown with a data capture device 232, which can include one or both of a laser scanner and an optical reader (see, e.g., the data capture device 300 of FIGS. 4 and 5).

Also in the present example the terminal 200 comprises a user input interface 244, which defines generally the organization of the input/output devices 212. Here, the user input interface 244 comprises a pointer controller 246, a keyboard 248, a display 250, and a touch panel 252 (FIG. 3). The terminal 200 also includes a trigger 254, which is disposed on the housing 202 and is useful to operate the data capture device 232.

Exemplary devices that can be used for devices of the user input interface 244 are generally discussed immediately below. Each device is implemented as part of, and often integrated into the housing 202 so as to permit an operator to input one or more operator initiated commands. These commands may specify and/or activate certain functions of the indicia reading terminal. They may also initiate certain applications, drivers, and other executable instructions to cause the terminal 200 to operate in a manner or mode desired.

Devices that are used for the pointer controller 246 are generally configured to translate the operator initiated command into motion of a virtual pointer provided by a graphical user interface (“GUI”) of the operating system of the terminal 200. It can include devices such as a thumbwheel, a roller ball, and a touch pad. In some other configurations, the devices may also include a mouse or other auxiliary device that is connected to the terminal 200 by way of, e.g., via wire or wireless communication technology.

Implementation of the keyboard 248 can be provided using one or more buttons, which are presented to the operator on the housing 202. The touch panel 252 (FIG. 3) may be configured to supplement or replace the need for buttons. For example, one of the GUIs of the operating system may be configured to provide one or more virtual icons for display on, e.g., the display 250 and touch panel 252 (FIG. 3), or as part of another display device on or connected to the terminal 200. Such virtual icons (e.g., buttons and slide bars) are configured so that the operator can select them, e.g., by pressing or selecting the virtual icon with a stylus (not shown) or a finger (not shown).

The virtual icons can also be used to implement the trigger 254. On the other hand, other devices for use as the trigger 254 may be supported within or as part of the housing 202. These include, but are not limited to, a button, a switch, or other types of actionable hardware that can be incorporated into the embodiments of the terminal 200. These can be used to activate one or more of the devices of the terminal 200, such as the data capture device 300 (FIGS. 4 and 5) discussed below.

Displays of the type suited for use on the terminal 200 are generally configured to display images, data, and GUIs associated with the operating system and/or software (and related applications) of the terminal 200. The displays can include, but are not limited to, LCD displays, plasma displays, LED displays, among many others and combinations thereof. Although preferred construction of the terminal 200 will include devices that display data (e.g., images, and text) in color, the display that is selected for the display 250 and/or the touch panel 252 (FIG. 2) may also display this data in monochrome (e.g., grayscale). It may also be desirable that the display 250 (and the touch panel 252 (FIG. 3)) is configured to display the GUI, and in particular configurations of the terminal 200 that display 250 (and the touch panel 252 (FIG. 3)) may have an associated interactive overlay, like a touch screen overlay on the touch panel 252 (FIG. 3). This configuration permits any display device to be used as part the GUI so as to permit the operator to interact with the virtual icons, the buttons, and other implements of the GUI to initiate the operator initiated commands, e.g., by pressing on the display 250 and/or the touch panel 252 (FIG. 3) with the stylus (not shown) or finger (not shown).

The form factor 204 is configured to accommodate some or all of the hardware and devices disclosed and contemplated herein. The form factor 204 defines the overall configuration of the housing 202. Suitable form factors that can be used for the housing 202 include, but are not limited to, cell phones, mobile telephones, personal digital assistants (“PDA”), as well as other form factors that are sized and shaped to be held, cradled, and supported by the end user or operator, e.g., in the operator's hand(s). The form factor 204 can also include gun-shaped devices, block-shaped devices, etc.

Referring back to FIGS. 2 and 3, the terminal 200 is shown in two terminal orientations including a first terminal orientation 256 (FIG. 2) and second terminal orientation 258 (FIG. 3). The first terminal orientation 256 exposes to the end user the first interactive surface 208, on which is found the pointer controller 246, the keyboard 248, and the display 250. In one implementation, these devices are activated (e.g., as the active device 136 (FIG. 1)) so that the end user can operate whatever functionality are accessible via the exposed or activated device. Likewise in FIG. 3, the second terminal orientation 258 exposes to the end user the second interactive surface 210. This orientation promotes activation of the touch panel 252, which is disposed on the second interactive surface 210.

In each of the first terminal orientation 256 (FIG. 2) and the second terminal orientation 258 (FIG. 3), some or all of the functions of the devices are disabled or de-activated (e.g., as the deactivated devices 138 (FIG. 1)) on the opposite side, e.g., on the second interactive surface 210 in FIG. 2 and on the first interactive side 208 in FIG. 3. Disabling the various devices reduces the likelihood that the end user will inadvertently enter or cause to be entered user initiated commands via the disabled devices. Moreover, because these devices may not be in the view of the end user (e.g., the device is not visible or exposed to the end user) and/or not utilized by the end user, these devices can be deactivated to save energy, e.g., battery power.

Noted in the example of FIGS. 2 and 3 is that the terminal 200 is rotated about 180° to expose the desired surface. The amount of rotation is determined, in one example, based on the configuration of the form factor 204. For rectangular (as illustrated) and similarly cube-like constructions, wherein the housing 202 has defined, parallel surfaces, the different sides are exposed by rotation of one of 90°, 180°, 270°, and 360°. On the other hand, the amount of rotation will vary across differently-shaped form factors, e.g., three-dimensional solids. For example, various input/output devices can be arranged on different surfaces of spherical, cylindrical, and polygonal solids, thereby changing the amount of the rotation required to expose, position, and/or locate the desired device in a position for access by the end user.

There is illustrated in FIGS. 4 and 5 an example of a data capture device 300 for use as, e.g., the data capture device 132, 232 discussed above. The data capture device 300 comprises an imaging module 302 for use as, e.g., the data capture device 132, 232. In one embodiment of the terminals of the present disclosure, the imaging module 302 can comprise a focus element 304 and an image sensor integrated circuit 306 that is disposed on a printed circuit board 308. Also disposed on the board 308 is an illumination pattern light source bank 310 (“the illumination bank 310”) and aiming pattern light source bank 312 (“the aiming bank 312”), which are each provided as a single light source. The imaging module 302 can also include an optical plate 314 that has optics for shaping light from illumination bank 310 and the aiming bank 312 into predetermined patterns.

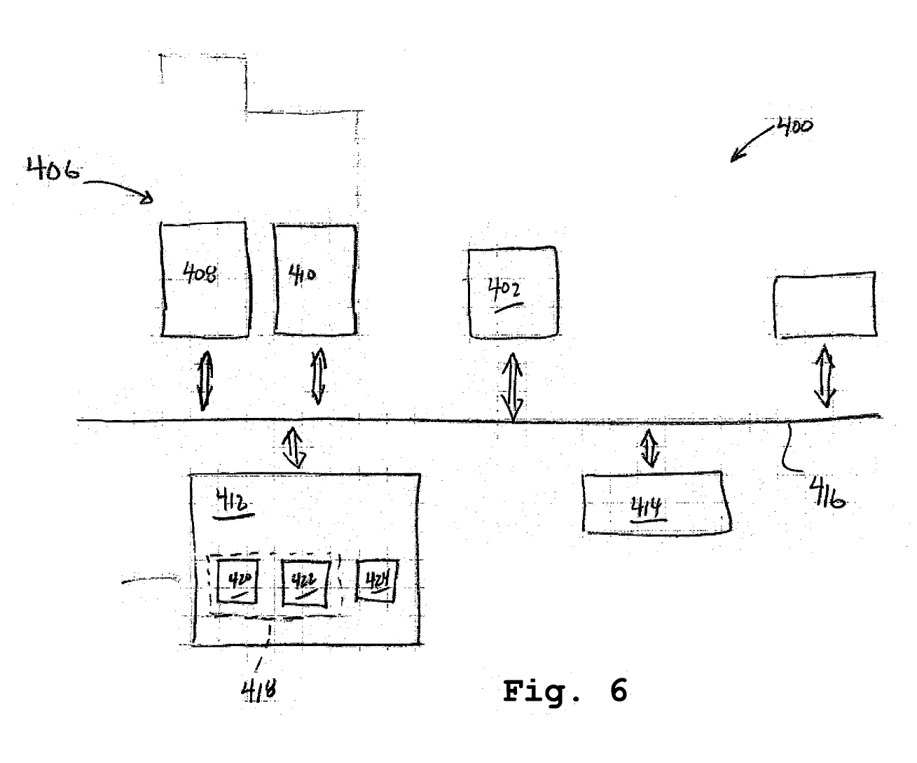

FIG. 6 is a block diagram of one example of a terminal 400 suitable for use with aspects of the present disclosure. Terminal 400 can be implemented as a device or apparatus, such as a handheld indicia reading terminal that, when placed in certain orientations, is configured for certain data input/data output functions. Terminal 400 comprises processing hardware 402, storage hardware 404, input/output devices 406 (e.g., first input/output device 408 and second input/output device 410), orientation hardware 412, and data capture hardware 414. In one embodiment, communication among and between the various components and elements of the terminal 400 is facilitated by a bus 416.

Processing hardware 402 can be one or more microprocessors, central processing units (CPUs), or other processor which run software programs for terminal 400. Multiple layers of software can be provided on a computer readable medium such as electronic memory or other storage medium incorporated as storage hardware 404. This software can include an operating system layer that is used to control and manage system resources, enable functions of application software, and interface application programs with other software and functions of the terminal 400. An orientation algorithm and/or algorithm layer can provide orientation algorithms that utilize and process data and information from orientation hardware 412.

Orientation hardware 412 includes motion sensors, including one or more inertial devices 418 such as, for example, a gyroscope 420 and/or an accelerometer 422. Gyroscope 420 can measure the angular velocity of the terminal 400 (or portion thereof). In one embodiment, from one to three gyroscopes can be provided, depending on the motion that is desired to be sensed in a particular embodiment. Some embodiments may employ more than three gyroscopes, which may enhance accuracy, increase performance, or improve reliability.

Accelerometer 422 can measure the linear acceleration of the terminal 400 (or portion thereof). From one to three accelerometers can be provided, depending on the motion that is desired to be sensed in a particular embodiment. Depending on preferred performance characteristics such as enhanced accuracy and reliability, more than three accelerometers may be used. In one example, if three gyroscopes 420 and three accelerometers 422 are deployed, then the orientation hardware 412 is equipped to sense and detect motion in six axes and/or six degrees of freedom. Additional degrees of freedom can be added by including in the orientation hardware 412 one or more additional ones of the gyroscopes 420 and the accelerometers 422.

In one embodiment, the orientation hardware 412 includes an orientation processor, generally identified by the numeral 424. Orientation processor 424 can include logic, microprocessors, and/or controllers of varying scope to provide processing of data and information from the various inertial devices 418. Motion algorithms may be implemented in orientation processor 424 that process incoming signals from, e.g., the gyroscope 420 and/or the accelerometer 422, and generate an input that is provided to the processing hardware 402. The input may be instructive of the orientation of the terminal such as, for example, instructive of which of the input/output devices 406 is to be activated and/or deactivated.

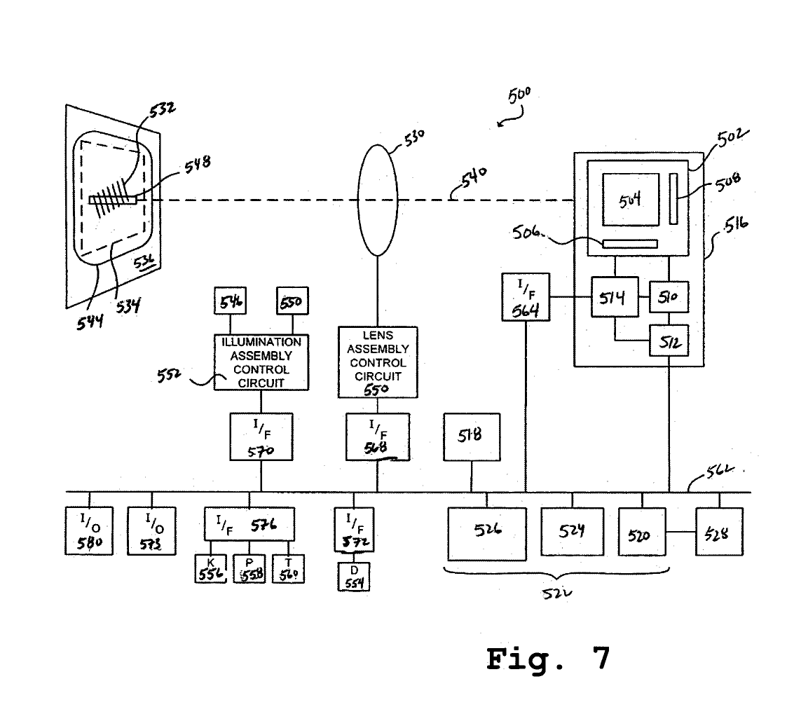

Illustrated in FIG. 7 is another example of a terminal 500, and more particularly an exemplary platform for use as the data capture hardware (e.g., the data capture hardware 130). The terminal 500 can include an image sensor 502 comprising a multiple pixel image sensor array 504 (“the image sensor array”) having a plurality of pixels arranged in rows and columns of pixels, including column circuitry 506 and row circuitry 508. Associated with the image sensor 502 can be amplifier circuitry 510, and an analog to digital converter 512 which converts image information in the form of analog signals read out of image sensor array 504 into image information in the form of digital signals. Image sensor 502 can also have an associated timing and control circuit 514 for use in controlling, e.g., the exposure period of image sensor 502, and/or gain applied to the amplifier 510.

The noted circuit components 502, 510, 512, and 514 can be packaged into an image sensor integrated circuit 516. In one example, image sensor integrated circuit 516 can be provided by an MT9V022 image sensor integrated circuit available from Micron Technology, Inc. In another example, image sensor integrated circuit 516 can incorporate a Bayer pattern filter. In such an embodiment, CPU 518 prior to subjecting a frame to further processing can interpolate pixel values intermediate of green pixel values for development of a monochrome frame of image data. In other embodiments, red, and/or blue pixel values can be utilized for the monochrome image data.

In the course of operation of terminal 500 image signals can be read out of image sensor 502, converted and stored into a system memory such as RAM 520. A memory 522 of terminal 500 can include RAM 520, a nonvolatile memory such as EPROM 524, and a storage memory device 526 such as may be provided by a flash memory or a hard drive memory. In one embodiment, terminal 500 can include CPU 518 which can be adapted to read out image data stored in memory 522 and subject such image data to various image processing algorithms. Terminal 500 can include a direct memory access unit (DMA) 528 for routing image information read out from image sensor 502 that has been subject to conversion to RAM 520. In another embodiment, terminal 500 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 502 and RAM 520 are within the scope and the spirit of the invention.

Referring to further aspects of terminal 500, terminal 500 can include an imaging lens assembly 530 for focusing an image of a form barcode 532 located within a field of view 534 on a substrate 536 onto image sensor array 504. Imaging light rays can be transmitted about an optical axis 540. The imaging lens assembly 530 can be adapted to be capable of multiple focal lengths and/or multiple best focus distances.

Terminal 500 can also include an illumination pattern light source bank 542 for generating an illumination pattern 544 substantially corresponding to the field of view 534 of terminal 500, and an aiming pattern light source bank 546 for generating an aiming pattern 548 on substrate 536. In use, terminal 500 can be oriented by an operator with respect to a substrate 536 bearing the form barcode 532 in such manner that aiming pattern 548 is projected on the form barcode 532. In the example of FIG. 6, the form barcode 532 is provided by a 1D bar code symbol. Form barcode could also be provided by 2D bar code symbols, stacked linears, or optical character recognition (OCR) characters, etc.

Each of illumination pattern light source bank 542 and aiming pattern light source bank 546 can include one or more light sources. The imaging lens assembly 530 can be controlled with use of lens assembly control circuit 550 and the illumination assembly comprising illumination pattern light source bank 542 and aiming pattern light source bank 546 can be controlled with use of illumination assembly control circuit 552. Lens assembly control circuit 550 can send signals to the imaging lens assembly 530, e.g., for changing a focal length and/or a best focus distance of imaging lens assembly 530. This can include for example providing a signal to the piezoelectric actuator to change the position of the variable position element of the focus element discussed above. Illumination assembly control circuit 552 can send signals to illumination pattern light source bank 542, e.g., for changing a level of illumination output by illumination pattern light source bank 542.

Terminal 500 can also include a number of peripheral devices such as display 554 for displaying such information as image frames captured with use of terminal 500, keyboard 556, pointing device 558, and trigger 560 which may be used to make active signals for activating frame readout and/or certain decoding processes. Terminal 500 can be adapted so that activation of trigger 560 activates one such signal and initiates a decode attempt of the form barcode 532.

Terminal 500 can include various interface circuits for coupling several of the peripheral devices to system address/data bus (system bus) 562, for communication with CPU 518 also coupled to system bus 562. Terminal 500 can include interface circuit 564 for coupling image sensor timing and control circuit 514 to system bus 562, interface circuit 568 for coupling the lens assembly control circuit 550 to system bus 562, interface circuit 570 for coupling the illumination assembly control circuit 552 to system bus 562, interface circuit 572 for coupling the display 554 to system bus 562, and interface circuit 576 for coupling the keyboard 556, pointing device 558, and trigger 560 to system bus 562.

In a further aspect, terminal 500 can include one or more I/O interfaces 573, 580 for providing communication with external devices (e.g., a cash register server, a store server, an inventory facility server, a peer terminal, a local area network base station, a cellular base station, etc.). I/O interfaces 573, 580 can be interfaces of any combination of known computer interfaces, e.g., Ethernet (IEEE 802.3), USB, IEEE 802.11, Bluetooth, CDMA, GSM, IEEE 1394, RS232 or any other computer interface.

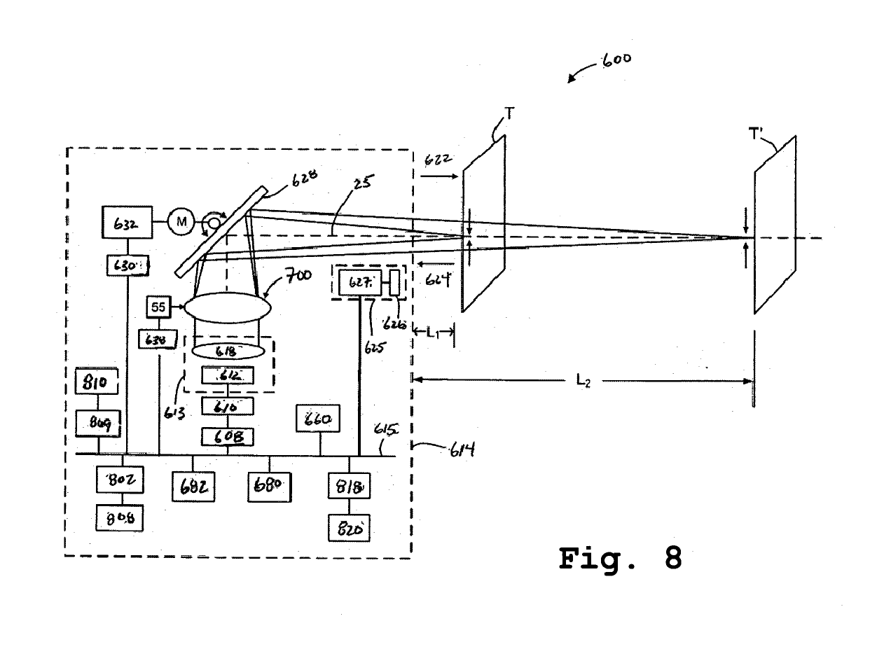

Another exemplary embodiment of a terminal 600 is illustrated in FIG. 8, and more particularly an exemplary platform for use as the data capture hardware (e.g., the data capture hardware 130). The terminal 600 hardware platform for use as the data capture hardware (e.g., the data capture hardware 130) in a terminal 600 (e.g., the terminals 100 and 200) is illustrated and described with reference to the schematic block diagram of FIG. 7. In FIG. 7, the terminal 600 includes a laser source 612 supported by a hand held housing 614. The laser source 612 can emit a laser beam along an optical path, or axis 25. Laser source 612 can be coupled to laser source control circuit 610. Light from laser source 612 can be shaped by collimating optics 618 and lens assembly 700. The combination of laser source 612 and collimating optics 618 can be regarded as a laser diode assembly 613. The laser beam travels in an emitting direction 622 along axis 25 and illuminates a target T, which in one embodiment includes a bar code. A scanning mirror reflector 628 disposed within the optical path defined by axis 25 oscillates to direct the laser beam across the entire surface to be scanned. Reflector 628 can be driven by scan, motor, M, which is coupled to control circuit 632.

The laser beam reflects off the target T and travels along axis 25 in a receiving direction 624 back to a detector 628. In the example wherein the target T includes a barcode, the incident laser light strikes areas of dark and white bands and is reflected. The reflected beam will thusly have variable intensity representative of the barcode pattern. Detector assembly 625 including detector 626 and analog to digital converter 627 can receive the reflected beam of variable intensity, generate an analog signal corresponding to the reflected beam, and convert it to a digital signal for storage into memory 680 where it can be processed by CPU 660 in accordance with a program stored in non-volatile memory 682, provided in a particular example by an EPROM.

For attempting to decode a bar code symbol, CPU 660 can process a digitized image signal corresponding to a scanned, reflected, and detected laser beam to determine a spatial pattern of dark cells and light cells and can convert each light and dark cell pattern determined into a character of character string via table lookup. Terminal 600 can include various interface circuits allowing CPU 660 to communicate with various circuits of terminal 600 including interface circuit 608 coupled to circuit 610 and system bus 615, interface circuit 630 coupled to motor control circuit 632, and interface circuit 638 coupled to electrical power input unit 55. Terminal 600 can also include trigger 808 which can be actuated to initiate a decode attempt. Manual trigger 808 can be coupled to interface circuit 802, which in turn can be coupled to system bus 615. Terminal 600 can also include a display 720 in communication with CPU 660 via interface 818 as well as pointer mechanism 810 in communication with CPU 660 via interface 809 coupled to system bus 615.

Referring to further aspects of the terminal 600, terminal 600 can include electrical power input unit 55 for inputting of energy for changing an optical characteristic of focusing apparatus 800, and therefore changing an optical characteristic (e.g., focal length, plane of optimal focus) of lens assembly 700. In one embodiment, an energy input to lens assembly 700 can be varied to vary a plane of optimum focus of a laser beam that is shaped by optics 618, reflector 628, and lens assembly 700 (collectively, “optics”). A plane (or distance) of optimum focus of a projected laser beam can be varied between a first distance L₁ of optimum focus and a second distance L₂ of optimum focus.

Where applicable it is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. An indicia reading terminal, comprising:
a terminal housing on which is disposed a first input/output device and a second input/output device; and
hardware coupled with the first input/output device and the second input/output device, the hardware comprising orientation hardware and data capture hardware comprising a data capture device that is operative for capture of data from a decodable indicia in response to a trigger signal initiated by an operator,
wherein in response to changes in orientation of the terminal housing the orientation hardware is configured to provide an input responsive to which the hardware is configured to activate one of the first input/output device and the second input/output device and deactivate one of the first input/output device and the second input/output device.

2. An indicia reading terminal according to claim 1, wherein the first input/output device and the second input/output device are positioned on opposite sides of the terminal housing.

3. An indicia reading terminal according to claim 1, wherein the orientation hardware comprises an inertial device that is configured to generate the input in response to motion of the terminal housing.

4. An indicia reading terminal according to claim 1, wherein the orientation hardware comprises an accelerometer

5. An indicia reading terminal according to claim 1, wherein the orientation hardware comprises a gyroscope.

6. An indicia reading terminal according to claim 1, wherein the data capture device comprises an optical reader.

7. An indicia reading terminal according to claim 1, wherein the data capture device comprises a laser scanner.

8. An indicia reading terminal according to claim 1, wherein the data capture hardware comprises an image sensor array comprising a plurality of pixels and a lens assembly for use in focusing an image onto the image sensor array, wherein the data capture hardware is operative for capture of a frame of image data responsively to the trigger signal.

9. An indicia reading terminal according to claim 1, wherein the data capture hardware comprises a laser source operable to emit a beam along an axis and illuminate a target on which the decodable indicia is disposed, a scanning mirror disposed intermediate the laser source and the target, the scanning mirror operable to deflect the beam emitted from the laser source so that the beam scans across the target, a focusing apparatus in optical communication with the laser source for focusing the beam on the target, and a detector operable to receive light scattered from the decodable indicia and convert the light into a signal.

10. An indicia reading terminal according to, claim 1, wherein the first input/output device comprises a touch panel and the second input/output device comprises a keyboard and a display.

11. An indicia reading terminal according to claim 1, wherein the terminal housing has a form factor with a first interactive side and a second interactive side on which is disposed, respectively, the first input/output device and the second input/output device, and wherein rotation of the terminal housing of at least 180° activates one of the first input/output device and the second input/output device and deactivates one of the first input/output device and the second input/output device.

12. An indicia reading terminal according to claim 11, wherein the form factor is of a personal digital assistant.

13. A system, comprising:
a terminal comprising a terminal housing with a first interactive side and a second interactive side on which is disposed an input/output device,
wherein incorporated in the terminal housing is hardware that comprises orientation hardware configured to recognize a position of each of the first interactive side and the second interactive side relative to an operator and data capture hardware that comprises a data capture device that is operative for capture of data from a decodable indicia in response to a trigger signal initiated by the operator,
wherein in response to a change in the position of the first interactive side and the second interactive side the orientation hardware is configured to provide an input responsive to which the hardware is configured to activate and deactivate the input/output device on each of the first interactive side and the second interactive side,
wherein the system includes the terminal and a server external to the terminal, and
wherein the terminal is operative for attempting to decode the decodable indicia.

14. A system according to claim 13, wherein the orientation hardware comprises an accelerometer

15. A system according to claim 13, wherein the orientation hardware comprises a gyroscope.

16. A system according to claim 13, wherein the data capture device comprises an imaging module.

17. A system according to claim 15, wherein the terminal is operative to transmit the data captured to the server.

18. A system for use in reading a bar code symbol disposed on a substrate, comprising:
a terminal having an image sensor array comprising a plurality of pixels, the terminal having a lens assembly for use in focusing an image onto the image sensor array, and a terminal housing incorporating the image sensor array; and
a server external to the terminal;
wherein the terminal is operative for capture a frame of image data responsively to a trigger signal initiated by an operator, the frame of image data representing the substrate and the bar code symbol,
wherein the terminal is operative to transmit the frame of image data to the server,
wherein the terminal housing has disposed thereon a first input/output device and a second input/output device positioned on opposite sides of the terminal housing, and
wherein the terminal is operative in response to a change in a position of the first input/output device and the second input/output device to activate one of the first input/output device and the second input/output device and deactivate one of the first input/output device and the second input/output device.

19. A system according to claim 18, wherein the terminal comprises orientation hardware comprising an inertial device that is responsive to movement of the terminal housing.

20. A system according to claim 19, wherein the inertial device comprises one or more of an accelerometer and a gyroscope.
